(19) United States
(12) Patent Application Publication
(10) Pub. No.: US 2009/0152015 A1
(43) Pub. Date: Jun. 18, 2009

(54) SUPERABRASIVE MATERIALS AND COMPACTS, METHODS OF FABRICATING SAME, AND APPLICATIONS USING SAME

(75) Inventors: Mohammad N. Sani, Orem, UT (US); Kenneth E. Bertagnolli, Riverton, UT (US); Craig H. Cooley, Saratoga Springs, UT (US); Jason Wiggins, Draper, UT (US)

Correspondence Address: Workman Nydegger c/o US SYNTHETIC CORP., 60 East South Temple, 1000 Eagle Gate Tower, Salt Lake City, UT, 84111, US

(73) Assignee: US SYNTHETIC CORPORATION, Orem, UT (US)

(21) Appl. No.: 12/336,721

(22) Filed: Dec. 17, 2008

Related U.S. Application Data
(63) Continuation-in-part of application No. 11/424,674, filed on Jun. 16, 2006.

(51) Int. Cl. C09K 3/14; B24D 18/00; B24D 3/04; E21B 10/46

(52) U.S. Cl. 175/420.2; 51/307; 428/143; 428/212; 428/148

(57) ABSTRACT

Embodiments of the present invention relate to superabrasive materials, superabrasive compacts employing such superabrasive materials, and methods of fabricating such superabrasive materials and compacts. One or more embodiments of a superabrasive material include a plurality of first superabrasive regions characteristic of being formed at least partially from a plurality of agglomerates, with each first superabrasive region including a plurality of first superabrasive grains that exhibit a first average grain size, and a matrix through which the plurality of first superabrasive regions is dispersed. The matrix includes a plurality second intercrystalline-bonded superabrasive grains that exhibit a second average grain size. The superabrasive material exhibits one or more of the following characteristics: (1) the first average grain size being less than that of the second average grain size; (2) the plurality of first superabrasive regions exhibiting a selectivity to be preferentially removed from the matrix; or (3) a thermal stability of the plurality of first superabrasive regions being greater than that of the matrix.

### CROSS-REFERENCE TO RELATED APPLICATIONS

This application is a continuation-in-part of U.S. patent application Ser. No. 11/424,674 filed on 16 Jun. 2006, the disclosure of which is incorporated herein, in its entirety, by this reference.

### BACKGROUND

Wear-resistant, superabrasive polycrystalline diamond compacts (“PDCs”) are utilized in a variety of mechanical applications. For example, PDCs are used in drilling tools (e.g., cutting elements, gage trimmers, etc.), machining equipment, bearing apparatuses, wire-drawing machinery, and in other mechanical apparatuses.

PDCs have found particular utility as superabrasive cutting elements in rotary drill bits, such as roller-cone drill bits, fixed-cutter drill bits, and roof drill bits. A PDC cutting element typically includes a superabrasive diamond layer (also known as a diamond table). The diamond table is formed and bonded to a substrate using an ultra-high pressure, ultra-high temperature (“HPHT”) process. The PDC cutting element may be brazed directly into a preformed pocket, socket, or other receptacle formed in a bit body of a rotary drill bit. The substrate may often be brazed or otherwise joined to an attachment member, such as a cylindrical backing. A rotary drill bit typically includes a number of PDC cutting elements affixed to the bit body. It is also known that a stud carrying the PDC may be used as a PDC cutting element when mounted to a bit body of a rotary drill bit by press-fitting, brazing, or otherwise securing the stud into a receptacle formed in the bit body.

Conventional PDCs are normally fabricated by placing a cemented-carbide substrate into a container or cartridge with a volume of diamond particles positioned on a surface of the cemented-carbide substrate. A number of such cartridges may be loaded into an HPHT press. The substrates and volume of diamond particles are then processed under HPHT conditions in the presence of a catalyst material that causes the diamond particles to bond to one another to form a matrix of bonded diamond grains defining a polycrystalline diamond (“PCD”) table. The catalyst material is often a metal-solvent catalyst, such as cobalt, nickel, iron, or alloys thereof, that is used for promoting intergrowth of the diamond particles.

In one conventional approach, a constituent of the cemented-carbide substrate, such as cobalt from a cobalt-cemented tungsten carbide substrate, liquefies and sweeps from a region adjacent to the volume of diamond particles into interstitial regions between the diamond particles during the HPHT process. The cobalt acts as a catalyst to promote intergrowth between the diamond particles, which results in formation of bonded diamond grains. Often, a solvent catalyst may be mixed with the diamond particles prior to subjecting the diamond particles and substrate to the HPHT process.

In another conventional approach for forming a PDC, a sintered PCD table may be separately formed and then leached to remove metal-solvent catalyst from interstitial regions between bonded diamond grains. The leached PCD table may be simultaneously HPHT bonded to a substrate and infiltrated with a non-catalyst material, such as silicon, in a separate HPHT process. The silicon may infiltrate the interstitial regions of the sintered PCD table from which the metal-solvent catalyst has been leached and react with the diamond grains to form silicon carbide.

Despite the availability of a number of different superabrasive materials, manufacturers and users of superabrasive materials continue to seek superabrasive materials that exhibit improved toughness, wear resistance, thermal stability, and/or other selected characteristics.

### SUMMARY

Embodiments of the invention relate to superabrasive materials, superabrasive compacts employing such superabrasive materials, and methods of fabricating such superabrasive materials and compacts. In one or more embodiments, a superabrasive material includes a plurality of first superabrasive regions characteristic of being formed at least partially from a plurality of agglomerates, with each first superabrasive region including a plurality of first superabrasive grains that exhibit a first average grain size. The superabrasive material further includes a matrix through which the plurality of first superabrasive regions is dispersed. The matrix includes a plurality of second intercrystalline-bonded superabrasive grains that exhibit a second average grain size. The superabrasive material exhibits one or more of the following characteristics: (1) the first average grain size being less than that of the second average grain size; (2) the plurality of first superabrasive regions exhibiting a selectivity to be preferentially removed from the matrix; or (3) a thermal stability of the plurality of first superabrasive regions being greater than that of the matrix.

In another embodiment, the superabrasive materials may be employed in a superabrasive compact. The superabrasive compact comprises a substrate including a superabrasive table bonded thereto that comprises any of the disclosed superabrasive materials.

Other embodiments relate to applications utilizing the disclosed superabrasive materials and superabrasive compacts in various articles and apparatuses, such as, rotary drill bits, machining equipment, bearing apparatuses, wire-drawing dies, and other articles and apparatuses.

In an embodiment, a method of fabricating a superabrasive material or a superabrasive compact is disclosed. A mixture may be sintered to form a superabrasive material. The mixture includes a plurality of first agglomerates exhibiting a first average agglomerate size, with each first agglomerate including a plurality of first superabrasive particles exhibiting a first average particle size. The mixture further includes a plurality of second agglomerates exhibiting a second average agglomerate size that is approximately equal to the first average agglomerate size, with each second agglomerate including a plurality of second superabrasive particles exhibiting a second average particle size that is greater than that of the first average particle size.

In an embodiment, another method of fabricating a superabrasive material or a superabrasive compact is disclosed. A mixture may be sintered to form a superabrasive material. The mixture includes a plurality of first agglomerates, with each of the first agglomerates including a plurality of first superabrasive particles. The mixture further includes a plurality of second agglomerates, with each second agglomerate including a plurality of second superabrasive particles and the plurality of second superabrasive particles having a composition that is different than that of the plurality of first superabrasive particles.

In an embodiment, yet another method of fabricating a superabrasive material or a superabrasive compact is disclosed. A mixture may be provided that comprises a plurality of first agglomerates, with each first agglomerate including a plurality of first superabrasive particles. The mixture further includes a plurality of second agglomerates, with each second agglomerate including a plurality of second superabrasive particles. The mixture may be sintered to form a superabrasive material including a plurality of first superabrasive regions formed at least partially from the plurality of first agglomerates and a plurality of second superabrasive regions formed at least partially from the plurality of second agglomerates, with the plurality of first superabrasive regions exhibiting a thermal stability greater than that of the plurality of second superabrasive regions.

### BRIEF DESCRIPTION OF THE DRAWINGS

The drawings illustrate several embodiments of the invention, wherein like reference numerals refer to like or similar elements in different views or embodiments shown in the drawings.

FIG. 1 is a schematic illustration of one or more embodiments of a method of fabricating a superabrasive material and the superabrasive material so-formed that includes a plurality of first superabrasive regions that enhance the wear resistance of the superabrasive material and a matrix through which the first superabrasive regions is dispersed that enhances the toughness of the superabrasive material.

FIG. 2 is a schematic illustration of one or more embodiments of a method of fabricating a superabrasive material and the superabrasive material so-formed that comprises a matrix including first superabrasive regions dispersed therethrough and having a selectivity to be preferentially removed from the matrix.

FIG. 3 is a schematic illustration of one or more embodiments of a method of fabricating a superabrasive material and the superabrasive material so-formed including thermally-stable superabrasive regions dispersed through a less thermally-stable matrix.

FIG. 4 is a cross-sectional view of an embodiment of a superabrasive compact.

FIG. 5 is a schematic illustration of an embodiment of a method for fabricating the superabrasive compact shown in FIG. 4.

FIG. 6 is an isometric view of an embodiment of a rotary drill bit that may employ one or more of the disclosed superabrasive compact embodiments.

FIG. 7 is a top elevation view of the rotary drill bit shown in FIG. 6.

FIG. 8 is an isometric cut-away view of an embodiment of a thrust-bearing apparatus, which may utilize any of the disclosed superabrasive compact embodiments as bearing elements.

FIG. 9 is an isometric cut-away view of an embodiment of a radial-bearing apparatus, which may utilize any of the disclosed superabrasive compact embodiments as bearing elements.

FIG. 10 is a schematic isometric cut-away view of an embodiment of a subterranean drilling system including the thrust-bearing apparatus shown in FIG. 8.

FIG. 11 is a side cross-sectional view of an embodiment of a wire-drawing die that employs a superabrasive compact fabricated in accordance with the teachings described herein.

FIG. 12 is a graph illustrating wear characteristics as a function of workpiece volume cut by the conventional PDC of comparative example 1 and PDCs fabricated according to working examples 2-3 of the invention.

FIG. 13 is a graph illustrating wear characteristics as a function of workpiece volume cut by the PDC of comparative example 4 and the PDC fabricated according to working example 5 of the invention.

FIG. 14 is a scanning electron photomicrograph that shows one of the fine-grained diamond regions in the center of the photomicrograph, with the matrix surrounding the fine-grained diamond region.

### DETAILED DESCRIPTION

Embodiments of the invention relate to superabrasive materials, superabrasive compacts employing such superabrasive materials, and methods of fabricating such superabrasive materials and compacts. The disclosed superabrasive materials may be used in a variety of applications, such as drilling tools (e.g., compacts, cutting elements, gage trimmers, etc.), machining equipment, bearing apparatuses, wire-drawing machinery, and other apparatuses. As used herein, the term “superabrasive” means a material that exhibits a hardness exceeding a hardness of tungsten carbide.

One or more embodiments of a superabrasive material include a plurality of first superabrasive regions characteristic of being formed at least partially from a plurality of agglomerates, with each first superabrasive region including a plurality of first superabrasive grains that exhibit a first average grain size. The superabrasive material further includes a matrix through which the plurality of first superabrasive regions is dispersed. The matrix includes a plurality of second intercrystalline-bonded superabrasive grains that exhibit a second average grain size. The superabrasive material exhibits one or more of the following characteristics: (1) the first average grain size being less than that of the second average grain size; (2) the plurality of first superabrasive regions exhibiting a selectivity to be preferentially removed from the matrix; or (3) a thermal stability of the plurality of first superabrasive regions being greater than that of the matrix.

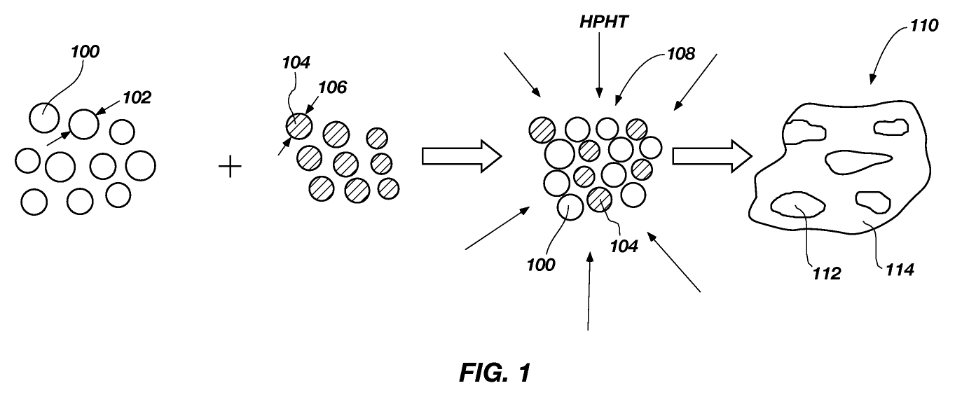

FIG. 1 is a schematic illustration of one or more embodiments of a method of fabricating a superabrasive material and the superabrasive material so-formed having a plurality of first superabrasive regions that enhance the wear resistance of the superabrasive material and a matrix through which the first superabrasive regions are dispersed that enhances the toughness of the superabrasive material. A plurality of first superabrasive agglomerates 100 that exhibit a first average agglomerate size 102 (e.g., a diameter or other major cross-sectional dimension) may be provided. Each first agglomerate 100 may include a plurality of first superabrasive particles (not shown), such as diamond particles, cubic boron nitride particles, or combinations of the foregoing. The first superabrasive particles of the first agglomerates 100 exhibit a first average particle size. In some embodiments, each first agglomerate 100 may include a non-diamond material (e.g., graphite particles, fullerenes, or combinations thereof) present in an amount of about 0.1 to about 10 weight percent. When the first superabrasive particles include diamond particles, such non-diamond materials may enhance growth between the diamond particles during HPHT sintering.

A plurality of second agglomerates 104 that exhibit a second average agglomerate size 106 (e.g., a diameter or other major cross-sectional dimension) may also be provided. The second average agglomerate size 106 is approximately equal to the first average agglomerate size 102. It is currently believed by the inventor that the first and second agglomerates 100 and 104 more uniformly mix with each other when the first and second average agglomerate sizes 102 and 106 are substantially equal. For example, the first and second average agglomerate sizes 102 and 106 may each be about 10 μm to about 200 μm (e.g., about 100 μm to about 200 μm). In other embodiments, the first and second average agglomerate sizes 102 and 106 may each be about 1 μm to about 10 μm (e.g., about 2 μm to about 5 μm). Each second agglomerate 104 may include a plurality of second superabrasive particles (not shown), such as diamond particles, cubic boron nitride particles, or combinations of the foregoing. In some embodiments, each second agglomerate 104 may include a non-diamond material (e.g., graphite particles, fullerenes, or combinations thereof) present in an amount of about 0.1 to about 10 weight percent. When the second superabrasive particles include diamond particles, such non-diamond materials may enhance growth between the diamond particles during HPHT sintering.

The second superabrasive particles exhibit a second average particle size that is greater than that of the first average particle size of the first superabrasive particles. Generally, the first average particle size may be about two or more times greater than the second average particle size. For example, the first average particle size of the first superabrasive particles may be about 0.1 μm to about 20 μm, and the second average particle size of the second superabrasive particles may about 15 μm to about 50 μm. In a more specific embodiment, the first average particle size may be about 10 μm and the second average particle size may be about 20 μm. In some embodiments, the second average particle size is about five or more times greater than the first average particle size. Additionally, in some embodiments, each agglomerate 100 and 104 may exhibit a bimodal or greater superabrasive particle size distribution.

In some embodiments, the first or second superabrasive particles exhibit a bimodal particle size distribution and the other of the first or second superabrasive particles exhibits a single modal distribution having a common mode with the bimodal particle size distribution. For example, if the first superabrasive particles of each first agglomerate 100 has a single modal particle size distribution with a mode at about 7 μm, the second superabrasive particles of each second agglomerate 104 may have a bimodal particle size distribution with respective first and second modes at about 7 μm and about 17 μm. In some embodiments, the first superabrasive particles of the first agglomerates 100 and/or the second agglomerates 104 may exhibit a bimodal particle size distribution having a first mode that is five or more times greater than a second mode. In some embodiments, both the first agglomerates 100 and the second agglomerates 104 exhibit different bimodal particle size distributions, but have a common mode. However, in such an embodiment, the superabrasive particles of the first agglomerates 100 still exhibit a first average particle size that is less than that of the second average particle size of the second agglomerates 104.

According to various embodiments, each of the first and second agglomerates 100 and 104 may be formed by freeze-drying, spray-drying, sieve granulation, combinations of the foregoing, or another suitable technique. For example, in freeze-drying, superabrasive particles, a solvent, a dispersant, and a binder (e.g., polyethylene glycol) may be injected through a nozzle and into a liquid nitrogen bath so that the first and second agglomerates 100 and 104 so-formed exhibit a generally spherical shape. In such an embodiment, the first superabrasive particles of the first agglomerates 100 may be bonded together with the binder and the second superabrasive particles of the second agglomerates 104 may also be bonded together with the binder. The binder may be removed by heating the first and second agglomerates 100 and 104 for a sufficient time and at a sufficient temperature to bake-off the binder, if needed or desired. For example, freeze-drying systems are commercially available from PowderPro AB of Sweden. In some embodiments, a sintering aid, such as a metal-solvent catalyst (e.g., cobalt, nickel, iron, or alloys thereof) or a carbonate catalyst (e.g., a Group IA or IIA metal carbonate) in particulate form may also be mixed with the superabrasive particles, solvent, dispersant, and binder.

Each agglomerate 100 and 104 may exhibit a generally ellipsoid geometry (e.g., spherical or nonspherical), a generally cylindrical geometry, or another selected geometry. Nonspherically shaped agglomerates may be formed by initially forming the agglomerates to exhibit the nonspherical shape or forming the agglomerates to exhibit a generally spherical geometry and compacting the agglomerates with rollers to form nonspherically shaped agglomerates.

The first and second agglomerates 100 and 104 may be mixed together to form a mixture 108, with the first agglomerates 100 randomly mixed with the second agglomerates 104. The mixing may be performed using any suitable mixing process, such as using a Turbula® mixing machine or other suitable apparatus or technique that generally randomly disperses the agglomerates 100 with the agglomerates 104 without significantly breaking apart the agglomerates 100 and 104. The relative weight percentage of the first and second agglomerates 100 and 104 in the mixture 108 may be selected to tailor the resultant physical and/or mechanical properties of the superabrasive material to be formed. For example, the first agglomerates 100 may comprise about 5 to about 50 weight percent of the mixture 108, such as about 5 to about 20 weight percent of the mixture 108 or about 5 to about 10 weight percent of the mixture 108.

The mixture 108 may be subjected to an HPHT sintering process in the presence of a sintering aid, such as a metal-solvent catalyst or carbonate catalyst, which promotes bonding between the superabrasive particles of the mixture 108. As previously discussed, the sintering aid may be in the form of metal-solvent catalyst or carbonate-catalyst particles that may be included in the mixture 108 prior to the HPHT sintering process. However, in other embodiments, the sintering aid may be in the form of a metal-solvent-catalyst foil or a green layer of metal-solvent-catalyst particles or carbonate-catalyst particles placed adjacent to the mixture prior to the HPHT sintering process; or the metal-solvent catalyst or carbonate catalyst may be included in the first and second agglomerates 100 and 104; or combinations of any of the foregoing catalyst introduction techniques may be used.

In order to efficiently sinter the mixture 108, the mixture 108 may be placed in a pressure transmitting medium, such as a refractory metal can, graphite structure, pyrophyllite and/or other pressure transmitting structure, or another suitable container or supporting element. The pressure transmitting medium, including the mixture 108, is subjected to an HPHT process using an ultra-high pressure press at a temperature of at least about 1000° C. (e.g., about 1100° C. to about 2200° C.) and a pressure of at least about 40 kilobar (e.g., about 50 kilobar to about 90 kilobar) for a time sufficient to sinter and form the superabrasive material 110 shown in FIG. 1.

As shown from the simplified microstructural representation in FIG. 1, the superabrasive material 110 so-formed exhibits a plurality of superabrasive regions 112 formed as a result of sintering the precursor first agglomerates 100. The superabrasive regions 112 include a plurality of intercrystalline-bonded first superabrasive grains (e.g., intercrystalline-bonded diamond grains or cubic boron nitride grains) that exhibit, for example, an average grain size of about 0.1 μm to about 20 μm. Each superabrasive region 112 may exhibit a cross-sectional dimension (e.g., a diameter or other major cross-sectional dimension) less than or equal to the first average agglomerate size 102 due to consolidation during the HPHT sintering process. For example, each superabrasive region 112 may exhibit an average cross-sectional dimension that is the same size as or similar to the size of the precursor first agglomerate 100 from which the superabrasive region 112 is formed. The intercrystalline-bonded first superabrasive grains define a plurality of first interstitial regions that may be occupied with a sintering aid used to form the superabrasive material 110. A matrix 114 may be formed as a result of sintering the precursor second agglomerates 104. The matrix 114 includes a plurality of intercrystalline-bonded second superabrasive grains (e.g., intercrystalline-bonded diamond grains or cubic boron nitride grains) that may, for example, exhibit an average grain size of about 15 μm to about 50 μm. The intercrystalline-bonded second superabrasive grains define a plurality of second interstitial regions that may also be occupied with a sintering aid used to form the superabrasive material 110. The relatively coarse superabrasive grain size of the matrix 114 provides a relatively tougher microstructure, while the relatively fine superabrasive grain size of the superabrasive regions 112 provide a relatively more wear-resistant microstructure. Although the matrix 114 is depicted as being generally continuous in the illustrated embodiment, in other embodiments, the matrix 114 may be generally discontinuous depending upon the relative volume fractions of the first and second agglomerates 100 and 104 used to form the superabrasive material 110. The matrix 114 may be characteristic of being formed from the second agglomerates 104, such as the presence of somewhat defined boundaries between superabrasive regions formed at least partially from the second agglomerates 104.

The geometry of the superabrasive regions 112 may resemble the geometry of the precursor first agglomerates 100 and characteristic of being formed at least partially from the precursor first agglomerates 100. For example, when the first agglomerates 100 are generally spherical, the as-sintered superabrasive regions 112 may also be generally spherical. However, due to nonuniform pressure applied to the first agglomerates 100 during the HPHT sintering process, due to fracturing of superabrasive particles, compaction of superabrasive particles, and other factors, the superabrasive regions 112 may exhibit a different geometry than the precursor first agglomerates 100. For example, when the first agglomerates 100 are generally spherical, the as-sintered superabrasive regions 112 may exhibit an elongated geometry or a less well-defined geometry due to shape changes that occur during HPHT processing.

Although the illustrated embodiment shown in FIG. 1 is directed to mixing only two different types of agglomerates, each having superabrasive particles of different average particle sizes, other mixtures are also contemplated. For example, in another embodiment, three or more agglomerates may be mixed together, with each agglomerate having approximately the same agglomerate size and the superabrasive particles of each agglomerate having a different average particle size. In such an embodiment, a matrix may be formed from coarse-grained superabrasive regions having relatively coarse-grained superabrasive grains, with a plurality of fine-grained superabrasive regions having relatively fine-grained superabrasive grains dispersed through the matrix. In some embodiments, an average cross-sectional dimension (e.g., a diameter) of the coarse-grained superabrasive regions of the matrix and an average cross-sectional dimension (e.g., a diameter) of the fine-grained superabrasive regions may be approximately equal to each other.

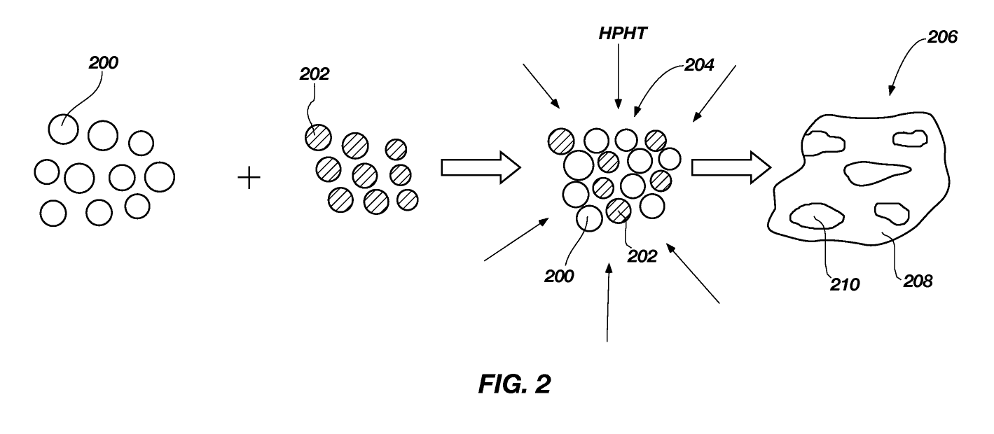

FIG. 2 is a schematic illustration of one or more embodiments of a method of fabricating a superabrasive material and the superabrasive material so-formed that comprises a matrix including first superabrasive regions dispersed therethrough and having a selectivity to be preferentially removed from the matrix. A plurality of first superabrasive agglomerates 200 may be provided. Each first agglomerate 200 may include a plurality of first superabrasive particles (not shown), such as diamond particles, cubic boron nitride particles, or combinations of the foregoing. A plurality of second agglomerates 202 may also be provided. Unlike the one or more embodiments described with respect to FIG. 1, the first and second agglomerates 200 and 202 may exhibit different or the same average agglomerate sizes (e.g., diameter). Each second agglomerate 202 may include a plurality of second superabrasive particles (not shown) and have a composition that is different than that of each first agglomerate 200. For example, in one embodiment, the first superabrasive particles may comprise diamond particles and the second superabrasive particles may comprise cubic boron nitride particles, aluminum oxide particles, other suitable ceramic particles having a composition different than the first superabrasive particles, or combinations of the foregoing. In another embodiment, the first superabrasive particles may comprise diamond particles and the second superabrasive particles may comprise silicon carbide particles.

The first and second agglomerates 200 and 202 may be formed using any of the previously described techniques (e.g., freeze-drying, spray-drying, sieve granulation, or combinations of the foregoing) and mixed together to form a mixture 204, with the first agglomerates 200 randomly mixed with the second agglomerates 202. The mixing may be performed using any suitable mixing process, such as using a Turbula® mixing machine or other suitable apparatus or technique that generally randomly disperses the agglomerates 200 with the agglomerates 202 without significantly breaking apart the agglomerates 200 and 202.

The mixture 204 is subjected to an HPHT sintering process in the presence of any of the aforementioned sintering aids to form a superabrasive material 206. The HPHT sintering process may be performed using the same or similar temperature and pressure conditions. For example, the sintering aid may be in the form of metal-solvent-catalyst or carbonate-catalyst particles that may be included in the mixture 204 prior to the HPHT sintering process. However, in other embodiments, the sintering aid may be in the form of a metal-solvent-catalyst foil or a green layer of metal-solvent-catalyst particles or carbonate-catalyst particles placed adjacent to the mixture prior to the HPHT sintering process; or the metal-solvent catalyst or carbonate catalyst may be included in the first and second agglomerates 200 and 202; or combinations of any of the foregoing catalyst introduction techniques may be used. As shown from the simplified microstructural representation in FIG. 2, the superabrasive material 206 so-formed includes a matrix 208 including superabrasive regions 210 dispersed therethrough. The matrix 208 is formed as a result of sintering the second agglomerates 202 and includes a plurality of second superabrasive grains intercrystalline bonded with each other to define a plurality of interstitial regions having a sintering aid disposed therein. The superabrasive regions 210 are formed as a result of sintering the first agglomerates 200 and may include a plurality of first superabrasive grains bonded directly together, bonded via a sintering aid or sintering by-product, or combinations of the foregoing.

The composition of the first agglomerates 200 is selected so that superabrasive regions 210 formed therefrom exhibit a selectivity to be preferentially removed from the matrix 208. For example, the matrix 208 may comprise intercrystalline-bonded diamond grains (i.e., polycrystalline diamond) having a sintering aid (e.g., cobalt) disposed in interstitial regions between the intercrystalline-bonded diamond grains and the superabrasive regions 210 may comprise bonded silicon carbide grains or cubic boron nitride grains, which may be chemically selectively removed from the matrix 208 without significantly removing portions of the matrix 208.

The volume fraction of the superabrasive regions 210 relative to the matrix 208 may be controlled by the relative weight percentages of the precursor first and second agglomerates 200 and 202 used to form the superabrasive material 206. In one embodiment, the relative weight percentages of the first and second agglomerates 200 and 202 are selected so that upon selectively removing the superabrasive regions 210 from the matrix 208, a network of at least partially interconnected passageways is formed throughout the superabrasive material 206. For example, when the superabrasive regions 210 comprise bonded silicon carbide grains and the matrix 208 comprises polycrystalline diamond, the superabrasive regions 210 may be removed using a suitable etchant, such as a suitable acid. Residual amounts of the superabrasive regions 210 may remain in the superabrasive material 206 after selective removal thereof The superabrasive material 206 having the passageways formed therein may be used as a filter, a stationary phase in separation apparatus such as in a chromatography apparatus, or another suitable application.

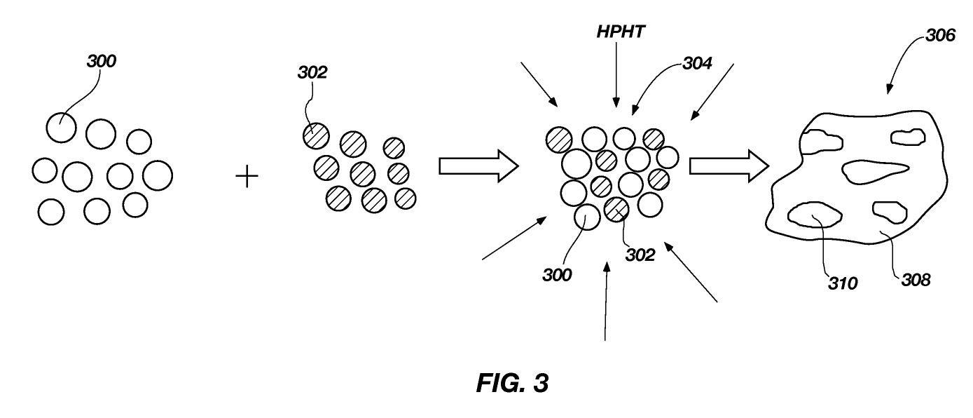

FIG. 3 is a schematic illustration of one or more embodiments of a method of fabricating a superabrasive material and the superabrasive material so-formed that includes thermally-stable superabrasive regions dispersed through a less thermally-stable matrix. A plurality of first superabrasive agglomerates 300 may be provided. Each first agglomerate 300 may include a mixture comprising diamond particles (not shown) and silicon particles (not shown). A plurality of second agglomerates 302 may also be provided. Each second agglomerate 302 may include a plurality of diamond particles (not shown). Unlike the one or more embodiments described with respect to FIG. 1, the first and second agglomerates 300 and 302 may exhibit different or the same respective average agglomerate sizes (e.g., diameter). The first and second agglomerates 300 and 302 may be formed using any of the previously described techniques (e.g., freeze-drying, spray-drying, sieve granulation, or combinations of the foregoing) and mixed together to form a mixture 304, with the first agglomerates 300 randomly mixed with the second agglomerates 302. As previously described, the mixing may be performed using any suitable mixing process, such as using a Turbula® mixing machine. The relative weight percentage of the first and second agglomerates 300 and 302 in the mixture 304 may be selected to tailor the resultant physical and/or mechanical properties of the superabrasive material to be formed. For example, the first agglomerates 300 may comprise about 5 to about 50 weight percent of the mixture 304, such as about 5 to about 20 weight percent of the mixture 304 or about 5 to about 10 weight percent of the mixture 304.

The mixture 304 may be subjected to an HPHT sintering process in the presence of any of the aforementioned sintering aids to form a superabrasive material 306. The HPHT sintering process may be performed using the same or similar temperature and pressure conditions. For example, the sintering aid may be in the form of metal-solvent-catalyst or carbonate-catalyst particles that may be included in the mixture 304 prior to the HPHT sintering process. However, in other embodiments, the sintering aid may be in the form of a metal-solvent-catalyst foil or a green layer of metal-solvent-catalyst particles or carbonate-catalyst particles placed adjacent to the mixture prior to the HPHT sintering process; or the metal-solvent catalyst or carbonate catalyst may be included in the first and second agglomerates 300 and 302′ or combinations of any of the foregoing catalyst introduction techniques may be used. As shown from the simplified microstructural representation in FIG. 3, the superabrasive material 306 so-formed includes a matrix 308 including thermally-stable superabrasive regions 310 dispersed therethrough. The matrix 308 is formed as a result of sintering the second agglomerates 302 and includes a plurality of diamond grains intercrystalline bonded with each other to define a plurality of interstitial regions having a sintering aid disposed therein. Although the matrix 308 is depicted as being generally continuous, in other embodiments, the matrix 308 may be generally discontinuous when the volume fraction of the second agglomerates 302 is low compared to the volume fraction of the first agglomerates 300.

The thermally-stable superabrasive regions 310 are formed at least partially from the first agglomerates 300 and may include a plurality of diamond grains bonded together with a reaction product between the silicon particles of the first agglomerates 300 and the diamond particles. For example, silicon carbide may be formed as a result of at least partially melting the silicon particles of the first agglomerates 300 during the HPHT sintering process and the at least partially molten silicon chemically reacting with the diamond particles. The thermally-stable superabrasive regions 310 so-formed exhibit a relatively greater thermal stability and relatively lower wear resistance than that of the matrix 308. The combination of the enhanced thermal stability of the superabrasive regions 310 increases the overall thermal stability of the superabrasive material 306 compared to if the superabrasive material 306 lacked the presence of the thermally-stable regions 310.

In another embodiment, the wear resistance of the superabrasive material 306 may be enhanced by introducing one or more different types of agglomerates into the mixture 304. For example, one or more different types of additional agglomerates may be mixed with the first and second agglomerates 300 and 302, with each additional agglomerate having superabrasive particles with a different average particle size that is less than that of the average particle size of the first agglomerates 300.

It is also noted that in any of the aforementioned embodiments described with respect to FIGS. 1-3, non-agglomerated (i.e., generally un-bonded) superabrasive particles may be mixed with the mixture 108, 204, or 304 of agglomerated particles to at least partially fill interstitial regions between adjacent agglomerates. Generally non-agglomerated superabrasive particles in the form of a powder (e.g., diamond particles, cubic boron nitride particles, or combinations thereof) having a selected average particle size may be mixed with the mixtures 108, 204, or 304 (see FIGS. 1-3). For example, the selected average particle size may be about 10 nm to about 2 μm. In some embodiments, as an alternative to or in addition to the non-agglomerated superabrasive particles, graphite particles, fullerenes, or combinations thereof may be introduced into the mixtures 108, 204, or 304 to at least partially fill interstitial regions between adjacent agglomerates. Providing non-agglomerated particles to the mixtures 108, 204, or 304 may prevent significant altering of the overall geometry of the agglomerates during HPHT processing.

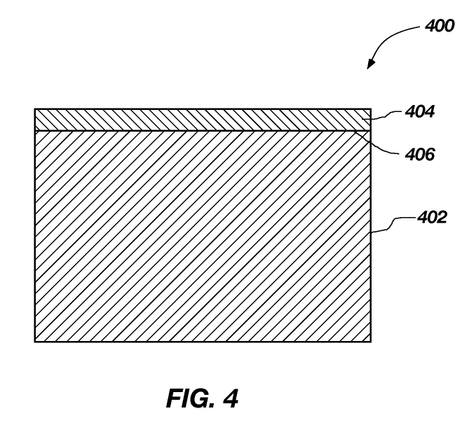

Referring to FIG. 4, the superabrasive materials disclosed herein (e.g., the superabrasive materials 110 or 306) may be employed in a superabrasive compact for cutting applications, bearing applications, or many other applications. FIG. 4 is a cross-sectional view of an embodiment of a superabrasive compact 400. The superabrasive compact 400 includes a substrate 402 bonded to a superabrasive table 404 that comprises any of the disclosed embodiments of superabrasive materials. The substrate 402 may be generally cylindrical or another selected configuration, without limitation. Although FIG. 4 shows the interfacial surface 406 of the substrate 402 as being substantially planar, the interfacial surface 406 may exhibit a selected non-planar topography, without limitation. The substrate 402 may include a metal-solvent catalyst, such as cobalt in cobalt-cemented tungsten carbide or another suitable material. The substrate 402 may also comprise, without limitation, cemented carbides including titanium carbide, niobium carbide, tantalum carbide, vanadium carbide, and combinations of any of the preceding carbides cemented with cobalt, iron, nickel, or alloys thereof

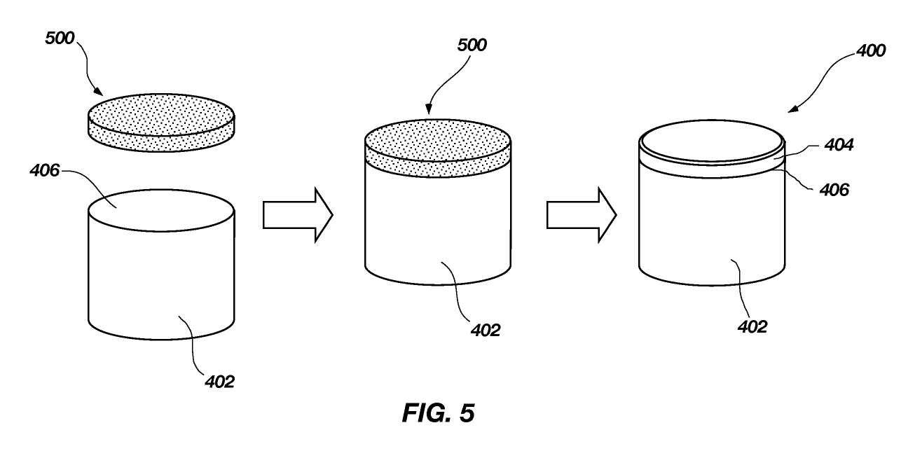

FIG. 5 shows a schematic illustration of an embodiment of a method for fabricating the superabrasive compact 400 shown in FIG. 4. Referring to FIG. 5, a mixture 500 (e.g., the mixture 108, 204 or 304) is positioned adjacent to the interfacial surface 406 of the substrate 402. As previously discussed, the substrate 402 may include a metal-solvent catalyst. The mixture 500 and the substrate 402 may be subjected to an HPHT process using conditions previously described with respect to the methods illustrated in FIGS. 1-3 to form the superabrasive compact 400. During the HPHT process, if present in the substrate 402, metal-solvent catalyst may be melted and sweep into the mixture 500 to promote sintering of the superabrasive particles thereof The superabrasive compact 400 includes a superabrasive table 404 that comprises any of the disclosed embodiments of superabrasive materials bonded to the interfacial surface 406 of the substrate 402. For example, if the mixture 500 is formed from the mixture 108 or 304, then the superabrasive table 404 is generally formed from the superabrasive material 110 or 306, respectively.

In other embodiments, the superabrasive table 404 may be separately formed using an HPHT sintering process and subsequently bonded to the interfacial surface 406 of the substrate 402 by brazing, using a separate HPHT bonding process, or any other suitable joining technique, without limitation. In yet another embodiment, the substrate 402 may be formed by depositing a binderless carbide (e.g., tungsten carbide) via chemical vapor deposition onto the interfacial surface 406.

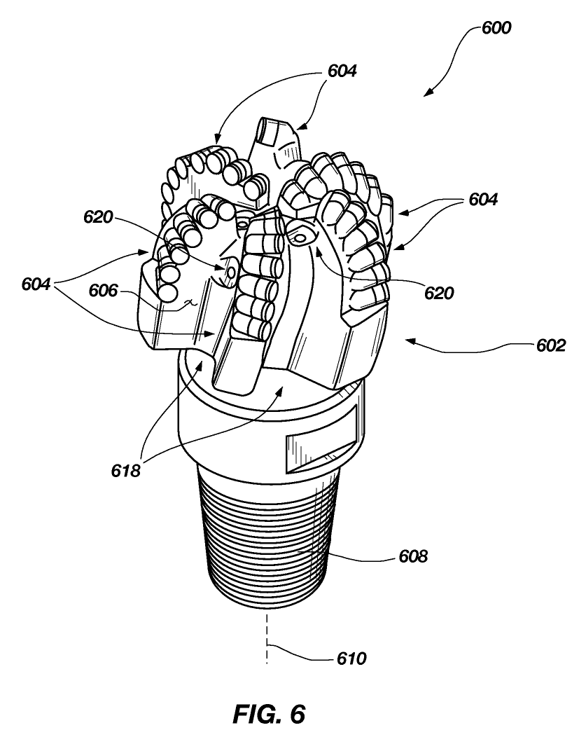

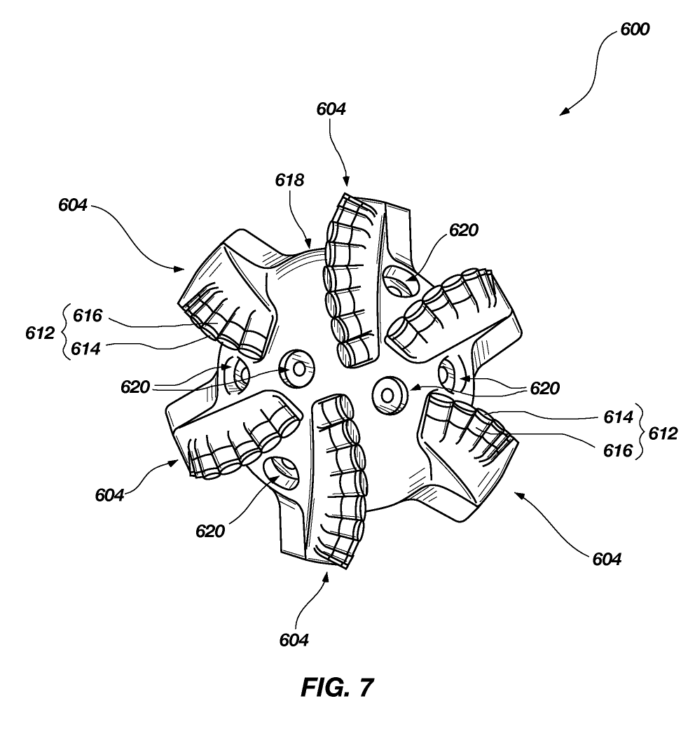

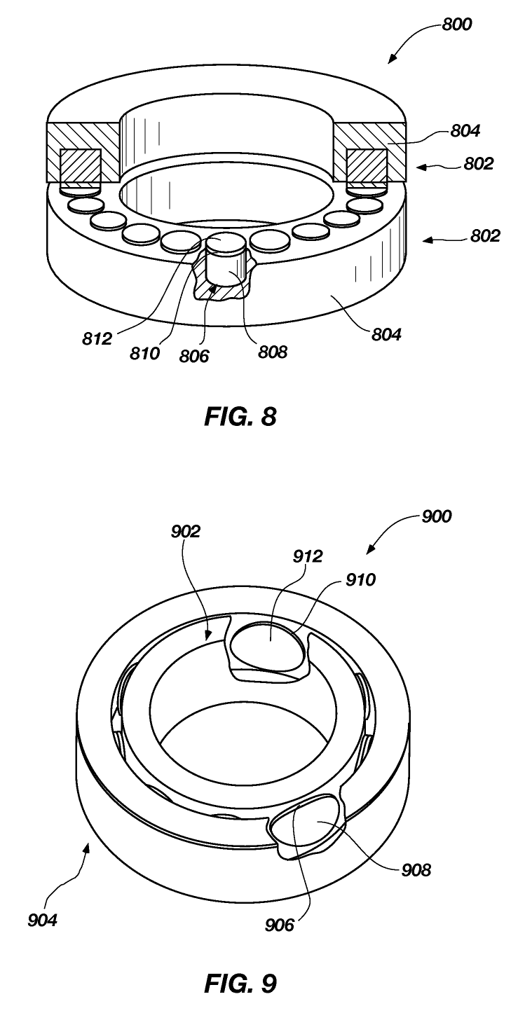

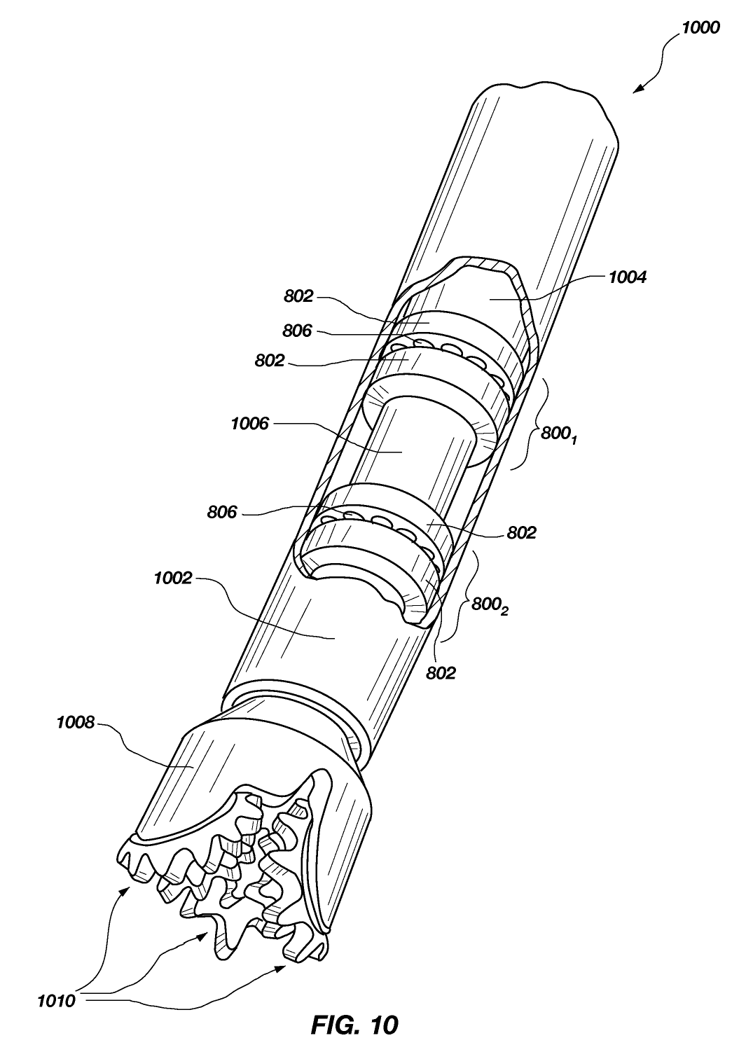

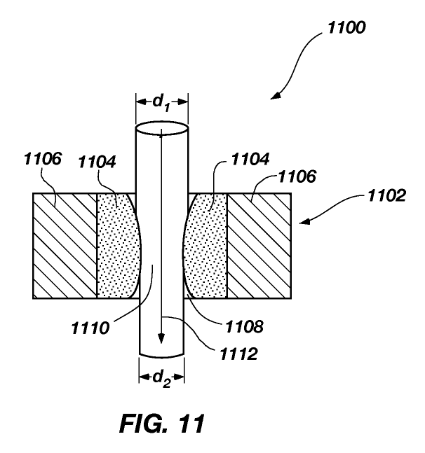

The disclosed embodiments of superabrasive compacts and superabrasive materials may be used in a number of different applications including, but not limited to, use in a rotary drill bit (FIGS. 6 and 7), a thrust-bearing apparatus (FIG. 8), a radial-bearing apparatus (FIG. 9), a subterranean drilling system (FIG. 10), and a wire-drawing die (FIG. 11). It should be emphasized that the various applications discussed above are merely some examples of applications in which the superabrasive compact and superabrasive material embodiments may be used. Other applications are contemplated, such as employing the disclosed superabrasive compacts and superabrasive material embodiments in friction stir welding tools.

FIG. 6 is an isometric view and FIG. 7 is a top elevation view of an embodiment of a rotary drill bit 600. The rotary drill bit 600 includes at least one superabrasive compact configured according to any of the previously described superabrasive compact embodiments. The rotary drill bit 600 comprises a bit body 602 that includes radially and longitudinally extending blades 604 with leading faces 606, and a threaded pin connection 608 for connecting the bit body 602 to a drilling string. The bit body 602 defines a leading end structure for drilling into a subterranean formation by rotation about a longitudinal axis 610 and application of weight-on-bit. At least one superabrasive cutting element, configured according to any of the previously described superabrasive compact embodiments (e.g., the superabrasive compact 400 shown in FIG. 4), may be affixed to rotary drill bit 600. With reference to FIG. 7, a plurality of superabrasive compacts 612 are secured to the blades 604. For example, each superabrasive compact 612 may include a superabrasive table 614 bonded to a substrate 616. More generally, the superabrasive compacts 612 may comprise any superabrasive compact disclosed herein, without limitation. In addition, if desired, in some embodiments, a number of the superabrasive compacts 612 may be conventional in construction. Also, circumferentially adjacent blades 604 define so-called junk slots 618 therebetween, as known in the art. Additionally, the rotary drill bit 600 may include a plurality of nozzle cavities 620 for communicating drilling fluid from the interior of the rotary drill bit 600 to the superabrasive compacts 612.

FIGS. 6 and 7 merely depict one embodiment of a rotary drill bit that employs at least one cutting element that comprises a superabrasive compact fabricated and structured in accordance with the disclosed embodiments, without limitation. The rotary drill bit 600 is used to represent any number of earth-boring tools or drilling tools, including, for example, core bits, roller-cone bits, fixed-cutter bits, eccentric bits, bicenter bits, reamers, reamer wings, or any other downhole tool including superabrasive compacts, without limitation.

The superabrasive materials and/or superabrasive compacts disclosed herein (e.g., the superabrasive compact 400 shown in FIG. 4) may also be utilized in applications other than rotary drill bits. For example, the disclosed superabrasive compact embodiments may be used in thrust-bearing assemblies, radial-bearing assemblies, wire-drawing dies, artificial joints, machining elements, and heat sinks.

FIG. 8 is an isometric cut-away view of an embodiment of a thrust-bearing apparatus 800, which may utilize any of the disclosed superabrasive compact embodiments as bearing elements. The thrust-bearing apparatus 800 includes respective thrust-bearing assemblies 802. Each thrust-bearing assembly 802 includes an annular support ring 804 that may be fabricated from a material, such as carbon steel, stainless steel, or another suitable material. Each support ring 804 includes a plurality of recesses (not labeled) that receive a corresponding bearing element 806. Each bearing element 806 may be mounted to a corresponding support ring 804 within a corresponding recess by brazing, press-fitting, using fasteners, or another suitable mounting technique. One or more, or all of bearing elements 806 may be configured according to any of the disclosed superabrasive compact embodiments. For example, each bearing element 806 may include a substrate 808 and a superabrasive table 810, with the superabrasive table 810 including a bearing surface 812.

In use, the bearing surfaces 812 of one of the thrust-bearing assemblies 802 bears against the opposing bearing surfaces 812 of the other one of the thrust-bearing assemblies 802. For example, one of the thrust-bearing assemblies 802 may be operably coupled to a shaft to rotate therewith and may be termed a “rotor.” The other one of the thrust-bearing assemblies 802 may be held stationary and may be termed a “stator.”

FIG. 9 is an isometric cut-away view of an embodiment of a radial-bearing apparatus 900, which may utilize any of the disclosed superabrasive compact embodiments as bearing elements. The radial-bearing apparatus 900 includes an inner race 902 positioned generally within an outer race 904. The outer race 904 includes a plurality of bearing elements 906 affixed thereto that have respective bearing surfaces 908. The inner race 902 also includes a plurality of bearing elements 910 affixed thereto that have respective bearing surfaces 912. One or more, or all of the bearing elements 906 and 910 may be configured according to any of the superabrasive compact embodiments disclosed herein. The inner race 902 is positioned generally within the outer race 904; thus, the inner race 902 and outer race 904 may be configured so that the bearing surfaces 908 and 912 may at least partially contact one another and move relative to each other as the inner race 902 and outer race 904 rotate relative to each other during use.

The radial-bearing apparatus 900 may be employed in a variety of mechanical applications. For example, so-called “roller-cone” rotary drill bits may benefit from a radial-bearing apparatus disclosed herein. More specifically, the inner race 902 may be mounted or affixed to a spindle of a roller cone and the outer race 904 may be affixed to an inner bore formed within a cone and such an outer race 904 and inner race 902 may be assembled to form a radial-bearing apparatus.

Referring to FIG. 10, the thrust-bearing apparatus 800 and/or radial-bearing apparatus 900 may be incorporated in a subterranean drilling system. FIG. 10 is a schematic isometric cut-away view of a subterranean drilling system 1000 that includes at least one of the thrust-bearing apparatuses 800 shown in FIG. 8 according to another embodiment. The subterranean drilling system 1000 includes a housing 1002 enclosing a downhole drilling motor 1004 (i.e., a motor, turbine, or any other device capable of rotating an output shaft) that is operably connected to an output shaft 1006. A first thrust-bearing apparatus 800₁ (FIG. 8) is operably coupled to the downhole drilling motor 1004. A second thrust-bearing apparatus 8002 (FIG. 8) is operably coupled to the output shaft 1006. A rotary drill bit 1008 configured to engage a subterranean formation and drill a borehole is connected to the output shaft 1006. The rotary drill bit 1008 is shown as a roller-cone drill bit including a plurality of roller cones 1010. However, other embodiments may utilize different types of rotary drill bits, such as a so-called “fixed-cutter” drill bit shown in FIGS. 6 and 7. As the borehole is drilled, pipe sections may be connected to the subterranean drilling system 1000 to form a drill string capable of progressively drilling the borehole to a greater depth within the earth.

A first one of the thrust-bearing assemblies 802 of the thrust-bearing apparatus 800₁ is configured as a stator that does not rotate and a second one of the thrust-bearing assemblies 802 of the thrust-bearing apparatus 800₁ is configured as a rotor that is attached to the output shaft 1006 and rotates with the output shaft 1006. The on-bottom thrust generated when the rotary drill bit 1008 engages the bottom of the borehole may be carried, at least in part, by the first thrust-bearing apparatus 800₁. A first one of the thrust-bearing assemblies 802 of the thrust-bearing apparatus 800₂ is configured as a stator that does not rotate and a second one of the thrust-bearing assemblies 802 of the thrust-bearing apparatus 800₂ is configured as a rotor that is attached to the output shaft 1006 and rotates with the output shaft 1006. Fluid flow through the power section of the downhole drilling motor 1004 may cause what is commonly referred to as “off-bottom thrust,” which may be carried, at least in part, by the second thrust-bearing apparatus 800₂.

In operation, drilling fluid may be circulated through the downhole drilling motor 1004 to generate torque and effect rotation of the output shaft 1006 and the rotary drill bit 1008 attached thereto so that a borehole may be drilled. A portion of the drilling fluid may also be used to lubricate and cool opposing bearing surfaces of the bearing elements 806 of the thrust-bearing assemblies 802.

FIG. 11 is a side cross-sectional view of an embodiment of a wire-drawing die 1100 that employs a superabrasive compact 1102 fabricated in accordance with the teachings described herein. The superabrasive compact 1102 includes an inner, annular superabrasive region 1104 comprising any of the superabrasive compact materials described herein that is bonded to an outer cylindrical substrate 1106 that may be made from the same materials as the substrate 402 shown in FIG. 4. The superabrasive region 1104 also includes a die cavity 1108 formed therethrough and configured for receiving and shaping a wire being drawn. The wire-drawing die 1100 may be encased in a housing (e.g., a stainless steel housing), which is not shown, to allow for handling.

In use, a wire 1110 of a diameter d, is drawn through die cavity 1108 along a wire-drawing axis 1112 to reduce the diameter of the wire 1110 to a reduced diameter d₂.

The following working examples set forth various formulations for forming PDCs. The following working examples provide further detail in connection with the specific embodiments described above.

### COMPARATIVE EXAMPLE 1

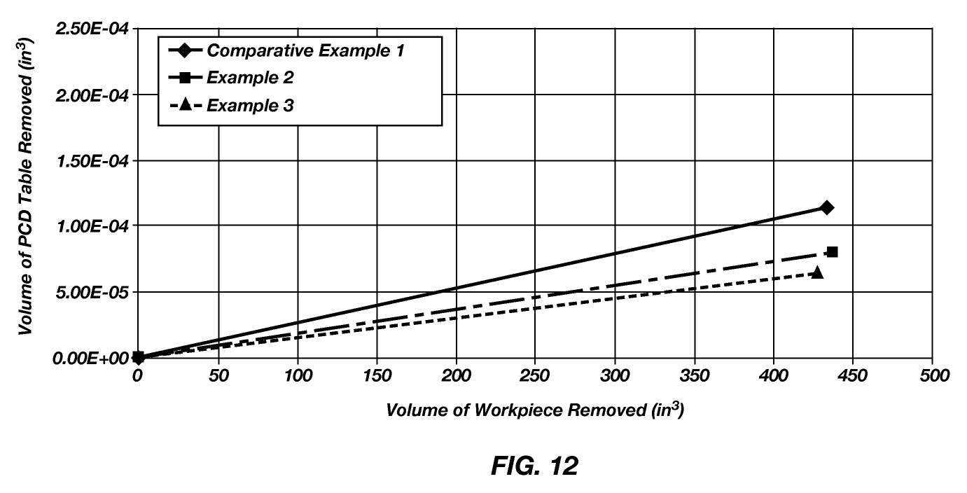

A conventional PDC was formed according to the following procedure. A mixture of diamond particles having an average particle size of about 19 μm was formed. The mixture was placed adjacent to a cobalt-cemented tungsten carbide substrate. The mixture and substrate were placed in a niobium can and subjected to a temperature of about 1400° C. and a pressure of about 55 kilobar using an HPHT press to form the PDC. The wear resistance was evaluated by measuring the volume of the PCD table of the conventional PDC removed versus the volume of a Barre workpiece removed in a vertical turret lathe test when the workpiece was cooled with coolant. The wear resistance results are shown in FIG. 12.

### EXAMPLE 2

A PDC was formed according to the following procedure. A plurality of first agglomerates each of which includes diamond particles bonded together with a polyethylene glycol binder were formed using a freeze-drying process. The diamond particles of each first agglomerate exhibited a bimodal particle size distribution, with each first agglomerate having an average particle size of about 11.5 μm. A plurality of second agglomerates each of which includes diamond particles bonded together with a polyethylene glycol binder were formed using a freeze-drying process. The diamond particles of each second agglomerate exhibited the same particle size distribution as the mixture of conventional example 1. Each first and second agglomerate was generally spherical and exhibited approximately the same diameter. The first and second agglomerates were mixed together using a Turbula® mixer to form a mixture, with the first agglomerates comprising about 5 weight percent of the mixture and the second it H agglomerates comprising about 95 weight percent of the mixture. The mixture was placed adjacent to a cobalt-cemented tungsten carbide substrate. The mixture and substrate were placed in a niobium can and subjected to a temperature of about 1400° C. and a pressure of about 55 kilobar using an HPHT press to form the PDC. As shown in FIG. 12, the PCD table of the PDC of example 2 exhibited a wear resistance that was greater than that of comparative example 1 as indicated by the volume of the workpiece removed versus the volume of the PCD table removed.

### EXAMPLE 3

A PDC was formed according to the following procedure. A plurality of first agglomerates each of which includes diamond particles bonded together with a polyethylene glycol binder were formed using a freeze-drying process. The diamond particles of each first agglomerate exhibited a bimodal particle size distribution, with each first agglomerate having an average particle size of 11.5 μm. A plurality of second agglomerates each of which includes diamond particles bonded together with a polyethylene glycol binder were formed using a freeze-drying process. The diamond particles of each second agglomerate exhibited the same particle size distribution as the mixture of conventional example 1. Each first and second agglomerate was generally spherical and exhibited approximately the same diameter. The first and second agglomerates were mixed together using a Turbula® mixer to form a mixture, with the first agglomerates comprising about 10 weight percent of the mixture and the second agglomerates comprising about 90 weight percent of the mixture. The mixture was placed adjacent to a cobalt-cemented tungsten carbide substrate. The mixture and substrate were placed in a niobium can and subjected to a temperature of about 1400° C. and a pressure of about 55 kilobar using an HPHT press to form the PDC. As shown in FIG. 12, the PCD table of the PDC of example 3 exhibited a wear resistance that is greater than that of comparative example 1 and example 2 as indicated by the volume of the workpiece removed versus the volume of the PCD table removed.

### COMPARATIVE EXAMPLE 4

A conventional PDC was formed according to the following procedure. A bimodal mixture of diamond particles having an average particle size of about 11.5 μm was formed. The mixture was placed adjacent to a cobalt-cemented tungsten carbide substrate. The mixture and substrate were placed in a niobium can and subjected to a temperature of about 1400° C. and a pressure of about 55 kilobar using an HPHT press to form the PDC.

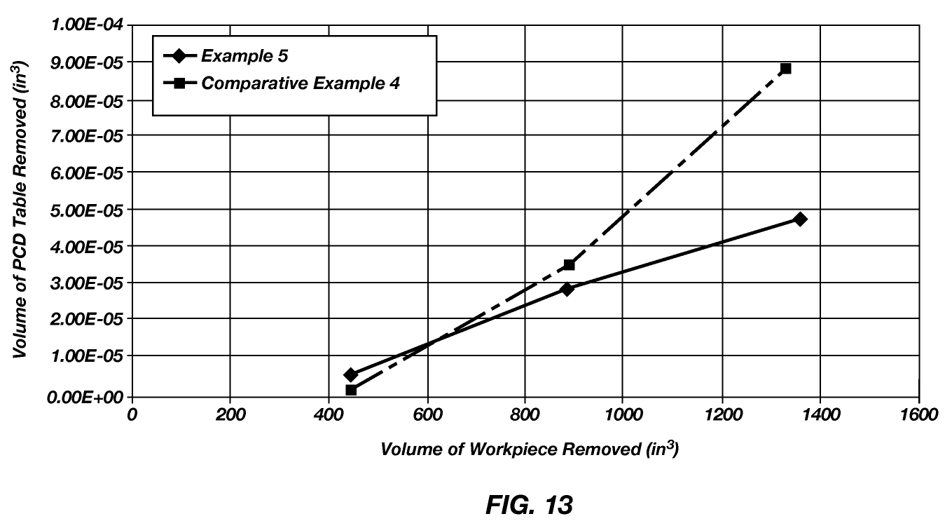

The wear resistance was evaluated by measuring the volume of the PCD table of the conventional PDC removed versus volume of a Barre workpiece removed in a vertical turret lathe test when the workpiece was cooled with coolant. The wear resistance results are shown in FIG. 13.

### EXAMPLE 5

A PDC was formed according to the following procedure. A plurality of first agglomerates each of which includes diamond particles bonded together with a polyethylene glycol binder were formed using a freeze-drying process. The diamond particles of each first agglomerate exhibited a bimodal particle size distribution, with each first agglomerate having an average particle size of about 11.5 μm. A plurality of second agglomerates each of which includes diamond particles bonded together with a polyethylene glycol binder were formed using a freeze-drying process. The diamond particles of each second agglomerate exhibited a bimodal particle size distribution having an average particle size of about 4.9 μm. Each first and second agglomerate was generally spherical and exhibited approximately the same diameter. The first and second agglomerates were mixed together using a Turbula® mixer to form a mixture, with the first agglomerates comprising about 85 weight percent of the mixture and the second agglomerates comprising about 15 weight percent of the mixture. The mixture was placed adjacent to a cobalt-cemented tungsten carbide substrate. The mixture and substrate were placed in a niobium can and subjected to a temperature of about 1400° C. and a pressure of about 55 kilobar using an HPHT press to form the PDC.

The wear resistance was evaluated by measuring the volume of the PCD table of the conventional PDC removed versus volume of the same Barre workpiece used in comparative example 4. As shown in FIG. 13, the PCD table of the PDC of example 5 has a greater wear resistance than the PCD table of comparative example 4 when used for an extended period of time to remove a large volume of the workpiece.

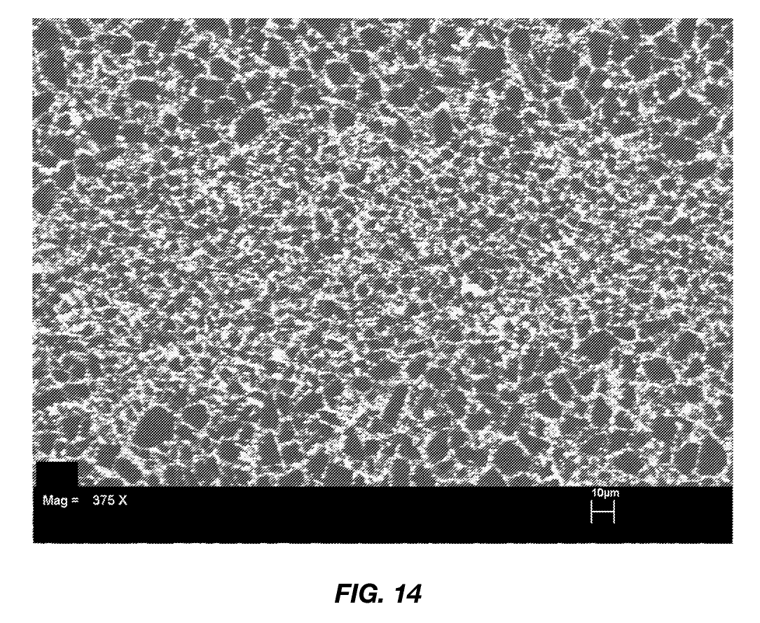

The microstructure of the PCD table of example 5 exhibited a plurality of fine-grained diamond regions dispersed in a coarse-grained matrix. The fine-grained diamond regions are the sintered product of the first agglomerates and include bonded fine diamond grains defining interstitial regions in which cobalt is disposed. The matrix is the sintered product of the second agglomerates and includes bonded coarse diamond grains defining interstitial regions in which cobalt is disposed. FIG. 14 is a scanning electron photomicrograph that shows one of the fine-grained diamond regions in the center of the photomicrograph, with the matrix surrounding the fine-grained diamond region. In FIG. 14, the dark blocky features are diamond grains and the bright regions are cobalt infiltrated from the cobalt-cemented tungsten carbide substrate. As apparent from FIG. 14, the fine-grained diamond region has a significantly finer average diamond grain size than the surrounding matrix.

While various aspects and embodiments have been disclosed herein, other aspects and embodiments are contemplated. The various aspects and embodiments disclosed herein are for purposes of illustration and are not intended to be limiting. Additionally, the words “including,” “having,” and variants thereof (e.g., “includes” and “has”) as used herein, including the claims, shall have the same meaning as the word “comprising” and variants thereof (e.g., “comprise” and “comprises”) and mean “including, but not limited to.”

What is claimed is:

1. A superabrasive material, comprising:
a plurality of first superabrasive regions characteristic of being formed at least partially from a plurality of agglomerates, each first superabrasive region including a plurality of first superabrasive grains exhibiting a first average grain size;
a matrix through which the plurality of first superabrasive regions is dispersed, the matrix including a plurality of second intercrystalline-bonded superabrasive grains exhibiting a second average grain size; and
wherein the superabrasive material exhibits at least one characteristic selected from the group consisting of: the first average grain size being less than that of the second average grain size; the plurality of first superabrasive regions exhibiting a selectivity to be preferentially removed from the matrix; and a thermal stability of the plurality of first superabrasive regions being greater than that of the matrix.

2. The superabrasive material of claim 1 wherein:
the plurality of first superabrasive regions exhibits a first average cross-sectional dimension; and
the matrix comprises a plurality of second superabrasive regions each of which includes a portion of the plurality of second intercrystalline-bonded superabrasive grains, the plurality of second superabrasive regions exhibiting a second average cross-sectional dimension approximately equal to the first average cross-sectional dimension.

3. The superabrasive material of claim 2 wherein the plurality of first superabrasive regions is randomly interspersed with the plurality of second superabrasive regions.

4. The superabrasive material of claim 1 wherein:
each first superabrasive region comprises diamond grains bonded together with silicon carbide; and
the plurality of second intercrystalline-bonded superabrasive grains comprises intercrystalline-bonded diamond grains.

5. The superabrasive material of claim 1 wherein:
the plurality of first superabrasive grains comprises at least one member selected from the group consisting of diamond grains and boron nitride grains; and
the plurality of second intercrystalline-bonded superabrasive grains comprises at least one member selected from the group consisting of diamond grains and boron nitride grains.

6. The superabrasive material of claim 1 wherein:
the plurality of first superabrasive grains comprises at least one member selected from the group consisting of silicon carbide and aluminum oxide; and
the plurality of second intercrystalline-bonded superabrasive grains comprises at least one member selected from the group consisting of diamond grains and boron nitride grains.

7. The superabrasive material of claim 2 wherein:
each first superabrasive region is generally ellipsoidal; and
each second superabrasive region is generally ellipsoidal.

8. The superabrasive material of claim 1 wherein:
the plurality of first superabrasive grains exhibits a first bimodal or greater distribution of grain size; and
the plurality of second intercrystalline-bonded superabrasive grains exhibits a second bimodal or greater distribution of grain size.

9. The superabrasive material of claim 1 wherein the first superabrasive regions are present in residual amounts.

10. The superabrasive material of claim 1 wherein the at least one characteristic is the plurality of first superabrasive regions exhibiting a selectivity to be preferentially removed from the matrix.

11. The superabrasive material of claim 1 wherein the at least one characteristic is the thermal stability of the plurality of first superabrasive regions being greater than that of the matrix.

12. The superabrasive material of claim 1 wherein the plurality of first superabrasive regions exhibits a selectivity to be preferentially chemically etched from the matrix.

13. The sintered superabrasive material of claim 1, further comprising a catalyst distributed therethrough.

14. A superabrasive compact, comprising:
a superabrasive table including a superabrasive material comprising:
a plurality of first superabrasive regions characteristic of being formed at least partially from a plurality of agglomerates, each first superabrasive region including a plurality of first superabrasive grains exhibiting a first average grain size;
a matrix through which the plurality of first superabrasive regions is dispersed, the matrix including a plurality of second superabrasive grains exhibiting a second average grain size; and
wherein the superabrasive table exhibits at least one characteristic selected from the group consisting of: the first average grain size being less than that of the second average grain size; and a thermal stability of the plurality of first superabrasive regions being greater than that of the matrix; and
a substrate bonded to the superabrasive table.

15. The superabrasive compact of claim 14 wherein the substrate comprises a cemented carbide material.

16. The superabrasive compact of claim 14 wherein the substrate comprises a binderless carbide material.

17. A rotary drill bit, comprising:
a bit body including a leading end having generally radially extending blades configured to facilitate drilling a subterranean formation; and
a plurality of cutting elements mounted to the blades, at least one of the cutting elements including a superabrasive material comprising:
a plurality of first superabrasive regions characteristic of being formed at least partially from a plurality of agglomerates, each first superabrasive region including a plurality of first superabrasive grains exhibiting a first average grain size;
a matrix through which the plurality of first superabrasive regions is dispersed, the matrix including a plurality of second superabrasive grains exhibiting a second average grain size; and
wherein the superabrasive material exhibits at least one characteristic selected from the group consisting of: the first average grain size being less than that of the second average grain size; and a thermal stability of the plurality of first superabrasive regions being greater than that of the matrix.

18. A method, comprising:
sintering a mixture to form a superabrasive material, wherein the mixture comprises:
a plurality of first agglomerates exhibiting a first average agglomerate size, each first agglomerate including a plurality of first superabrasive particles exhibiting a first average particle size; and
a plurality of second agglomerates exhibiting a second average agglomerate size that is approximately equal to the first average agglomerate size, each second agglomerate including a plurality of second superabrasive particles exhibiting a second average particle size that is greater than that of the first average particle size.

19. The method of claim 18, further comprising:
prior to the act of sintering a mixture to form the superabrasive material:
forming the plurality of first agglomerates;
forming the plurality of second agglomerates; and
mixing the plurality of first agglomerates with the plurality of second agglomerates to form the mixture.

20. The method of claim 19 wherein:
forming the plurality of first agglomerates comprises forming the plurality of first agglomerates to exhibit a first bimodal or greater distribution of superabrasive particle size; and
forming the plurality of second agglomerates comprises forming the plurality of second agglomerates to exhibit a second bimodal or greater distribution of superabrasive particle size.

21. The method of claim 18, further comprising:
prior to the act of sintering a mixture to form the superabrasive material, positioning the mixture at least proximate to a substrate; and
wherein sintering a mixture to form the superabrasive material comprises forming the superabrasive material as a superabrasive table over the substrate.

22. A method, comprising:
sintering a mixture to form a superabrasive material, wherein the mixture comprises:
a plurality of first agglomerates, each of the first agglomerates including a plurality of first superabrasive particles; and
a plurality of second agglomerates, each second agglomerate including a plurality of second superabrasive particles, with the plurality of second superabrasive particles having a composition that is different than that of the plurality of first superabrasive particles.

23. The method of claim 22, further comprising:
prior to the act of sintering a mixture to form the superabrasive material:
forming the plurality of first agglomerates;
forming the plurality of second agglomerates; and
mixing the plurality of first agglomerates with the plurality of second agglomerates to form the mixture.

24. The method of claim 22 wherein:
the first superabrasive particles comprise diamond particles; and
the second superabrasive particles comprises silicon carbide.

25. The method of claim 22, further comprising selectively removing at least a portion of the plurality of second superabrasive particles from the superabrasive material.

26. The method of claim 22 wherein the plurality of first agglomerates exhibits a first average agglomerate size that is approximately equal to a second average agglomerate size of the plurality of second agglomerates.

27. A method, comprising:
providing a mixture comprising:
a plurality of first agglomerates, each agglomerate including a plurality of first superabrasive particles; and
a plurality of second agglomerates, each second agglomerate including a plurality of second superabrasive particles; and
sintering the mixture to form a superabrasive material including a plurality of first superabrasive regions formed at least partially from the plurality of first agglomerates and a plurality of second superabrasive regions formed at least partially from the plurality of second agglomerates, the plurality of first superabrasive regions exhibiting a thermal stability greater than that of the plurality of second superabrasive regions.

28. The method of claim 27 wherein:
the plurality of first agglomerates exhibits a first bimodal or greater distribution of superabrasive particle size; and
the plurality of second agglomerates exhibits a second bimodal or greater distribution of superabrasive particle size.

29. The method of claim 27, further comprising:
prior to the act of sintering the mixture to form a superabrasive material including a plurality of first superabrasive regions formed at least partially from the plurality of first agglomerates and a plurality of second superabrasive regions formed at least partially from the plurality of second agglomerates, positioning the mixture at least proximate to a substrate; and
wherein sintering the mixture to form a superabrasive material including a plurality of first superabrasive regions formed at least partially from the plurality of first agglomerates and a plurality of second superabrasive regions formed at least partially from the plurality of second agglomerates comprises forming the superabrasive material as a superabrasive table over the substrate.

30. The method of claim 29 wherein the plurality of first agglomerates exhibits a first average agglomerate size that is approximately equal to a second average agglomerate size of the plurality of second agglomerates.

31. A superabrasive material fabricated according to a method, the method comprising:
sintering a mixture including:
a plurality of first agglomerates exhibiting a first average agglomerate size, each first agglomerate including a plurality of first superabrasive particles exhibiting a first average particle size; and
a plurality of second agglomerates exhibiting a second average agglomerate size that is approximately equal to the first average agglomerate size, each second agglomerate including a plurality of second superabrasive particles exhibiting a second average particle size that is greater than that of the first average particle size.
